(19) United States
(12) Patent Application Publication
(10) Pub. No.: US 2026/0131683 A1
(43) Pub. Date: May 14, 2026

(54) Mobile EV Charging

(71) Applicant: Frederica shields, River Rouge, MI (US)

(72) Inventor: Frederica shields, River Rouge, MI (US)

(21) Appl. No.: 18/940,925

(22) Filed: Nov. 8, 2024

(51) Int. Cl. B60L 53/57; B60L 53/67; F01N 3/021; F02B 63/04; H02J 7/14; H02J 9/00

(52) U.S. Cl. CPC B60L 53/57; B60L 53/67; F01N 3/021; F02B 63/04; H02J 7/1415; H02J 7/1423; H02J 9/00

(57) ABSTRACT

The present innovation introduces a mobile electric vehicle (EV) charging system designed to enhance charging flexibility and accessibility. Integrating a powerful 80-kW or 120-kW charger into a retrofitted box truck, the system addresses the limitations of traditional static charging stations by delivering on-site power directly to vehicles. Key features include single or dual-charging capability, enabling simultaneous service to two vehicles, and a diesel-powered generator for continuous operation, freeing system from grid constraints. Specialized retrofitting ensures durability against road conditions, while an advanced air filtration system guarantees environmental safety. Additionally, the system is equipped with windows and an upward exhaust fan on the roof, facilitating effective heat dissipation and maintaining optimal internal temperatures. An application-based appointment system enhances responsiveness, ensuring rapid service delivery within minutes of request. This mobile solution uniquely combines mobility, efficiency, and environmental consideration, offering a comprehensive and innovative approach to EV charging.

### COPYRIGHT NOTICE

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL DESCRIPTION OF INVENTION

The technical invention is a mobile electric vehicle (EV) charging system integrated within a retrofitted box truck, featuring an 80-kW or 120-kW charger capable of simultaneously charging two vehicles and powered by a diesel generator for continuous operation, designed to withstand challenging road conditions.

### BACKGROUND

In the rapidly evolving field of electric vehicle (EV) charging, ongoing innovations strive to address the constraints of traditional systems by enhancing efficiency, accessibility, and adaptability. Existing solutions like the Passive Flux Bridge (U.S. Pat. No. 10,668,829B2) and wireless charging methods, including the “System and Method for Field Adjustment in Wireless Charging Pads” (US20230347757A1), exemplify significant strides towards making charging systems more efficient and conducive to diverse environments. However, these approaches often remain constrained by the need for proximity to fixed infrastructure or limitations on mobile adaptability.

The present invention diverges from these established technologies by introducing a mobile charging solution that integrates a powerful 80-kW or 120-kW charger into a retrofitted box truck, which fundamentally addresses the issues of mobility and infrastructure dependence. Unlike stationary or wireless systems that may require specific site installations or precise alignment for operation, this mobile system offers the flexibility to deliver on-site charging directly to vehicles, especially in locations devoid of existing infrastructure. Its charging capability (single or dual) further distinguishes it from prior art by enabling simultaneous delivery of power to multiple vehicles, optimizing service efficiency and resource utilization.

Additionally, the incorporation of a diesel-powered generator allows for continuous operation independent of grid availability, a distinction that significantly expands service reach and utility. The combination of advanced retrofitting for durability and environmental safety features, such as a sophisticated air filtration system, underscores the system's adaptability and commitment to operational integrity across various terrains and conditions. Thus, this invention marks a significant departure from prior technologies by combining mobility, resilience, and environmental mindfulness into a singular, transformative solution for EV charging.

The mobile EV charging system caters to drivers'needs for immediate and reliable charging services that can meet them at their point of need. By eliminating the constraints of fixed-location chargers and introducing a robust system immune to typical mobile charging flaws, this system represents a significant leap forward in EV charging technology. By augmenting fleet capabilities and offering versatile power solutions beyond vehicles, the system also supports municipal and cooperative users in ensuring operational continuity amidst an increasingly electrified transport sector.

The invention aligns with growing global trends toward sustainable energy utilization, offering an adaptable, clean, and efficient solution for electric vehicle users. This milestone in charging technology will enhance EV usability and adoption by overcoming the infrastructural and logistical barriers that have historically deterred potential users from transitioning to electric vehicles.

### SUMMARY

The present invention introduces a pioneering mobile electric vehicle (EV) charging system, designed to offer unparalleled flexibility and convenience, and revolutionize EV charging solutions. This innovative system integrates a robust 80-kW or 120-kW charger into a specially retrofitted box truck, addressing the limitations of traditional static charging stations by bringing power directly to vehicles. This provides a critical advantage for drivers stranded in areas lacking nearby infrastructure.

Equipped with charging capabilities (single or dual), this mobile system can charge two vehicles simultaneously, optimizing time and resources. It features a diesel-powered generator for continuous mobility, eliminating the need for a fixed base recharging and enhancing operational efficiency. The vehicle is meticulously retrofitted to endure road travel rigors while preserving its functionality across various environmental conditions.

Operational and environmental safety are prioritized with a high-efficiency air filtration system within the generator, suitable for urban areas concerned with air quality. Innovatively, the system includes windows and an upward exhaust fan at the vehicle's roof, facilitating effective heat dissipation and enhancing thermal management.

The 80-kW or 120-kW charger satisfies modern EV demands for quick and reliable access, with the charging feature (single or dual) offering benefits in high-density areas or emergencies. Additionally, the system can serve as an emergency power supply for small buildings, expanding its utility for municipal and corporate use during outages.

Customer experience is streamlined via an application-based appointment system, enabling efficient scheduling and rapid service within five minutes of a request, underscoring its reliability and customer-centric focus.

In conclusion, this mobile EV charging system provides a comprehensive solution for accessible electric vehicle charging, merging high-capacity charging with mobility and operational resilience. The invention becomes a multifaceted tool, ready to address immediate and auxiliary power needs, advancing the mobility and sustainability of the electrified transport sector.

While structural features and methodological operations are detailed, the scope of the invention as defined by appended claims is not confined to these descriptions, allowing flexibility in feature arrangement and operation sequence.

### DESCRIPTION OF FIGURES

The accompanying figures illustrate the innovative elements of the mobile EV charging system, offering visual clarity on its construction and operation.

FIG. 1 provides a detailed illustration of the generator system, showing the integrated air filtration unit. This design showcases the generator's construction, highlighting the strategic placements that ensure emission safety during operation, and emphasizing its compact size, which allows it to fit comfortably within the truck's mobile structure

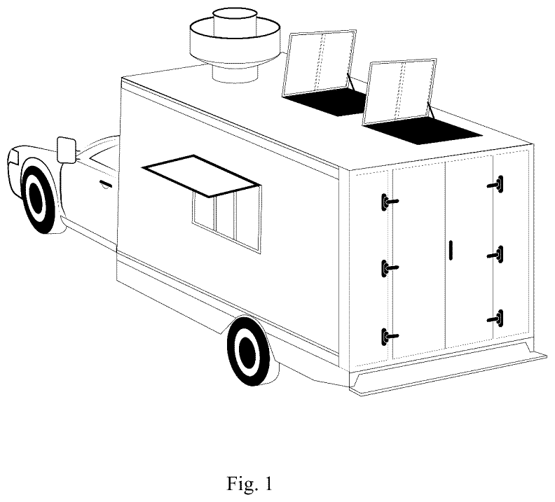

FIG. 2 provides a detailed sideview illustration of the generator system, showing the integrated air filtration unit.

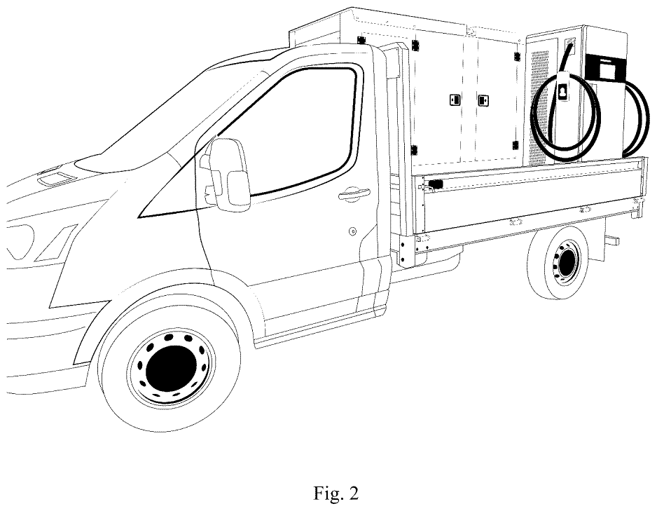

FIG. 3 displays a schematic of the exhaust system that connects to the generator then out the top of the truck.

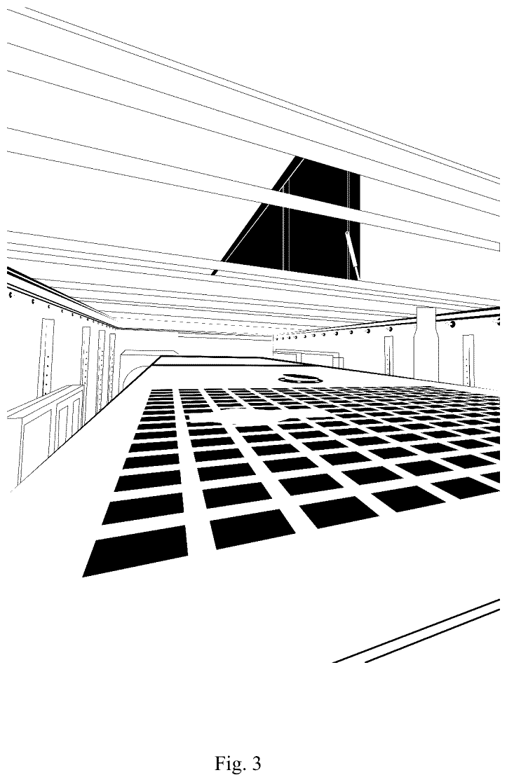

FIG. 4 displays the top view of the generator with openings that allow the air to exhaust.

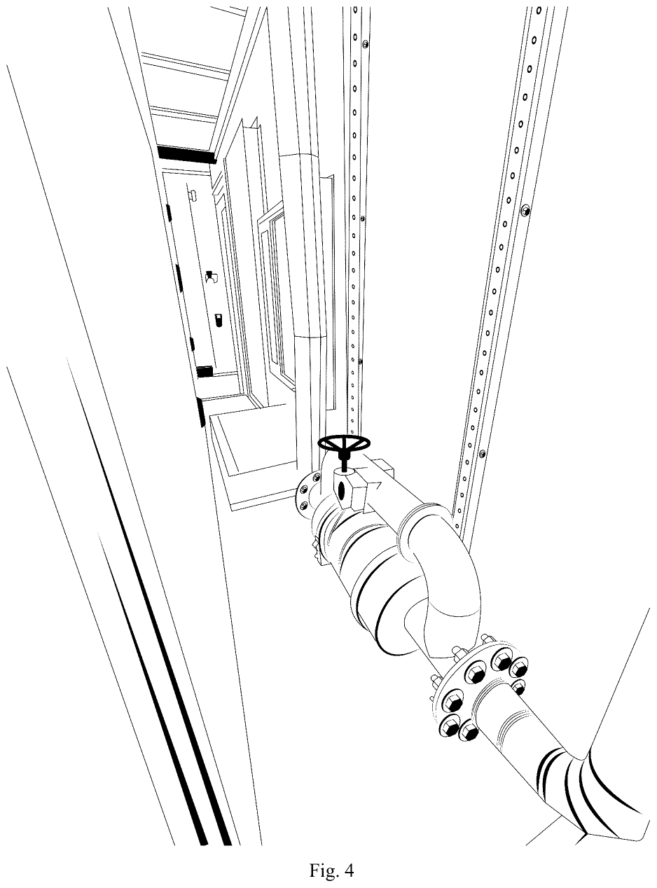

### DETAILED DESCRIPTION OF INVENTION

The detailed architecture of this mobile EV charging system embodies several critical components and features that interconnect seamlessly to produce a robust, efficient, and dependable vehicle charging solution. The fundamental element is a 80-kW or 120-kW charger housed within a retrofitted box truck. The retrofitting process involves reinforcing the truck to handle various road-induced stresses, ensuring uninterrupted functionality even when traversing through challenging terrains.

Central to the on-board charging operation is the diesel generator designed for continuous power supply. This generator facilitates uninterrupted operation without external charging, effectively transforming the truck into a self-sustaining charging unit. The generator's design incorporates state-of-the-art filtration technology to reduce emissions, making it safe and environmentally friendly for both operators and the surrounding environment.

The charger inside the truck can support two electric vehicles at once. This feature hinges on an intelligent power management system that ensures optimal distribution of electricity, adapting to the specific requirements and capacities of connected vehicles. This single or dual charging capacity means the system is not just versatile but also particularly time-efficient, doubling the number of vehicles charged within the same timeframe as traditional systems.

In terms of retrofitting, the chassis and suspension of the box truck are augmented to withstand frequent road travel, handling impacts from potholes, bumps, and other environmental variables that could impact the integrity and performance of sensitive electrical components. The stabilized retrofitting ensures that regardless of road conditions, the system's functionality remains immune to disruptions.

To enhance thermal management and operational efficiency, the vehicle has been outfitted with strategically positioned windows and an upward exhaust fan on the roof. This design facilitates effective heat dissipation, ensuring the internal components remain at optimal operating temperatures even under rigorous use. The windows and fan work in tandem to expel heat efficiently, thereby maintaining the integrity of the system and preventing overheating during prolonged operations. This innovation not only improves the system's durability but also ensures consistent performance, crucial for both urban deployment and emergency scenarios where reliable operation is imperative.

Additionally, the system is integrated with a user-friendly application that allows customers to seamlessly book charging appointments. This app facilitates user interaction from start to finish by allowing customers to efficiently schedule service requests and receive real-time updates on the mobile unit's estimated arrival time. This feature enhances the customer experience by reducing wait times and providing a transparent service model. Users benefit from the convenience of having their vehicles charged wherever necessary, without having to locate a stationary charging station themselves.

Moreover, beyond serving individual vehicle owners, the system offers significant utility to fleet operators, city officials, and rental agencies who might require rapid deployment of charging services across varied locations. This flexibility ensures that transport and operations involving electric vehicles remain uninterrupted, supporting continuous fleet mobility and deployment.

The system also doubles as an emergency power unit, capable of providing backup power to medium-sized buildings, a feature particularly beneficial during power outages. This ability to provide auxiliary power makes the invention valuable not only for charging electric vehicles but also for communities and businesses looking to mitigate the impacts of power failures.

Overall, the invention sets itself apart through its comprehensive approach to mobile EV charging, delivering a unique blend of mobility, single or dual-charging capabilities, robustness against road conditions, and multifunctional capabilities in power supply.

1. A mobile electric vehicle (EV) charging system, comprising:
a. a box truck outfitted with a 80-kW or 120-kW charger;
b. a diesel-powered generator integrated within said truck for providing continuous electrical power to the charger;
c. the ability to charge two electric vehicles simultaneously; and
d. a retrofitted chassis capable of enduring varied road conditions such as bumps and potholes to maintain operational integrity during travel.

2. The mobile EV charging system of claim 1, further comprising an advanced air filtration system attached to the generator to ensure operator safety by mitigating hazardous emissions during operation.

3. The mobile EV charging system of claim 1, wherein the 80-kW or 120-kW charger is equipped with an intelligent power management system that dynamically allocates power between connected vehicles based on their individual power needs.

4. The mobile EV charging system of claim 1, wherein the system includes a user-accessible mobile application that facilitates booking appointments and provides real-time tracking of the charging truck's location and estimated time of arrival.

5. The mobile EV charging system of claim 1, wherein the generator is additionally configured to provide auxiliary power to medium-sized buildings in the event of a power outage.

6. The mobile EV charging system of claim 1, wherein the retrofitted chassis includes reinforced suspension components designed to prevent damage to the electrical equipment from routine travel or environmental conditions typical to urban and rural roadways.

7. The mobile EV charging system of claim 1, further comprising windows and an upward exhaust fan positioned on the roof of the truck to facilitate effective heat dissipation and maintain optimal internal temperatures.
